(19) United States
(12) Patent Application Publication
(10) Pub. No.: US 2016/0325467 A1
(43) Pub. Date: Nov. 10, 2016

(54) SCREW FOR USE IN AN EXTRUDER, METHOD FOR CONVERTING A SCREW, AND AN EXTRUDER

(71) Applicant: Reifenhäuser GmbH & Co. KG Maschinenfabrik, Troisdorf (DE)

(72) Inventor: Mateusz SZURGOT, Koln (DE)

(21) Appl. No.: 15/151,164

(22) Filed: May 10, 2016

(30) Foreign Application Priority Data
May 10, 2015 (DE) 10 2015 005 790.1

(51) Int. Cl. B29B 7/42; B29C 47/60; B29B 7/58

(52) U.S. Cl. CPC B29B 7/429; B29B 7/58; B29C 47/60

(57) ABSTRACT

A screw for use in an extruder or in a twin screw extruder exhibits a mandrel and a number of segments held on the mandrel disposed axially to one another. Between the mandrel and a segment, a separate torque entrainer is disposed. The torque entrainer is in contact with the mandrel at a contact surface area of the mandrel, wherein the contact surface area is notch-free.

To transmit the high occurring torque, the elements are connected to the mandrel in a positive-locking manner and also axially braced.

### CROSS-REFERENCE TO RELATED APPLICATIONS

This application is related to and claims the benefit of German Patent Application No. DE 10 2015 005 790.1, filed on May 10, 2015, the contents of which are herein incorporated by reference in its entirety.

### TECHNICAL FIELD

The disclosure relates to a screw for use in an extruder or a twin screw extruder and an extruder or a twin screw extruder with such a screw.

### BACKGROUND

Screws customarily have a modular design. They can therefore be adapted very flexibly to changing tasks and product characteristics. The modular construction of a screw results in a rod-shaped core, the so-called mandrel, in practice also often referred to as a shaft or a bearing shaft, and individual screw elements that are pushed onto the mandrel. The elements perform the classic functions of a screw in the extrusion process, such as conveying, kneading, mixing or shearing the plastic to be delivered and passed through.

To transmit the high occurring torque, the elements are connected to the mandrel in a positive-locking manner and also axially braced.

DE 10 2008 028 289 A1 discloses a screw, in which the torque is transmitted from segment to segment on the front side via a gearing.

DE 103 30 530 A1 describes a shaft, onto which a sleeve is welded. Segments are threaded on up to the stop. DE 10 2011 112 148 A1, DE 10 2004 042 746 B4 and DE 196 21 571 C2 respectively disclose special gearings between the screw segments and the mandrel.

The disclosure is based on providing an alternative or improvement over conventional screws.

### SUMMARY

According to a first aspect of the disclosure, a screw is provided for use in an extruder, whereby the screw exhibits a mandrel and a number of segments held on the mandrel and disposed axially to one another, whereby a separate torque entrainer is disposed between the mandrel and one segment and whereby the torque entrainer is in contact with the mandrel at a contact surface of the mandrel, whereby the screw is characterized in that the contact surface of the mandrel is low notch or preferably notch-free.

With regards to terminology, the following is explained:

The “segments” are those components of the screw, which affect the helical passage or the number of helical passages for the plastification of the plastic to be passed through the extruder in cooperation with the cylinder of the extruder or, in the case of a twin screw extruder, also with the segments of the second screw.

In each case, two axially adjacent segments bump against one another axially indirectly or directly at their segment boundaries. The resulting slot between the segments, in the simplest case therefore a circular ring, has to be sealed to prevent plastic melt passing into the interior, i.e. toward the mandrel. To accomplish this, the segments are typically axially braced. The negative normal force provides an adequate seal.

The “torque entrainer” has to cooperate with at least one segment. When loading the screw with a torque, on a segment on the mandrel or on both, the torque entrainer transmits torque, at least in large part, between the segment and the mandrel. In addition, the torque can be transmitted from one segment to the axially adjacent second segment.

In doing so, the torque entrainer itself is not configured in one piece with either the first or the second segment, but is instead a separate element of the assembled screw.

The torque entrainer can comprise multiple individual parts, or it can be only one part.

In general it should be expressly noted that indefinite articles and numbers, such as one, two etc., are always to be understood as “at least” statements, i.e. “at least one . . . ”, “at least two . . . ”, etc., provided that it is not explicitly or implicitly apparent from the respective context that it can only mean or is intended to mean “exactly one . . . ”, “exactly two . . . ” etc. The “contact surface” of the mandrel is a surface against which the torque entrainer rests, typically but not necessarily, with as large an area as possible. Therefore, the contact surface is the surface via which, upon application of a torque, i.e. upon a rotation of the mandrel relative to the screw cylinder, the required eccentric force, i.e. the required torque to co-rotate the segments, is transmitted to the segments, a force sufficient to move the melt, which during operation is in the extruder, against its inertial force is applied.

When viewing the screw in cross section, there will be at least one recess between the cross section of the mandrel and the cross section of the radially inward opening of the segments. This is specifically the recess, into which the torque entrainer has to be fitted in order to create a functional screw.

There does not necessarily have to be a full surface “contact”. Rather, it is also sufficient if there are a number, preferably a large number, of discrete punctiform or linear contacts between the mandrel and the torque entrainer. The presence of smaller notches on the contact surface is thus conceivable. In general, however, the dynamic stresses on both the mandrel and the torque entrainer are smaller, the more extensive the contact between the torque entrainer and the mandrel at its contact surface, and/or the closer the contact surface comes to the ideal of being completely free of notches.

For a conventional screw, the presented first aspect of the disclosure now provides for the contact surface of the mandrel to be free of notches. In other words, in cross section on the contact surface, the mandrel is free of notches.

Smaller notches should therefore still be included in the term “notch freedom”, as long as notch freedom exists at least substantially.

Mechanically this results in a lower stress than conventional screws.

With conventional screws, feather keys are customarily provided between the mandrel and the segments as torque entrainers. Independent of the specific configuration of the conventional torque entrainer, however, a notch effect generally occurs on incised or notched bodies when the bodies are subjected to tensile, shear or torsional stresses. The notch effect is built upon two mechanisms, namely, on the one hand, a local stress concentration that can be described with a stress concentration factor and, on the other hand, a supporting effect, which describes that the material and the specific damping behavior of the stress concentration counteract the stress peaks at the notch. The fatigue notch factor is the quotient of the stress concentration factor and the notch sensitivity.

Additional information can be found in DIN 743-2: Calculation of load capacity of shafts and axles-Part 2: Theoretical stress concentration factors and fatigue notch factors.

While the geometries that have been used to date in the construction of extruder screws have consciously accepted the notching on the mandrel in order to achieve a more secure positive-locking connection, the disclosure presented here has consciously taken the opposite approach, and strives for a stress concentration factor that is as low as possible.

For this reason, the disclosure seeks to ensure that, at least where a notch was typically mandatory, namely on the contact surface, the cross section of the mandrel now no longer has a notch. In this context a “notch” is to be understood as at least a concave profile of the cross section within the contact surface. Such a thing is to be avoided here, at least with a corner in the cross section.

As a result of the notch-poorness, in particular the notch freedom, of the mandrel on its contact surface, i.e. at least within the contact surface, preferably however also on the boundaries of the contact surface, the stress peaks, which act on the mandrel during operation of the screw, are reduced quite significantly. It is therefore possible, for example, to realize the mandrel with previously known materials, which would result in a considerably longer service life for the mandrel; or it is possible to make the mandrel from another material, in the course of which the material can be designed to better suit the now existing load.

The disclosure therefore leads optionally to an extension of the service life or to cost savings, or to both. An increase in the performance of the machine can be achieved as well.

According to a second aspect of the disclosure, a screw is provided for use in an extruder, whereby the screw exhibits a mandrel and a number of segments held on the mandrel and disposed axially to one another, whereby a separate torque entrainer is disposed between the mandrel and one segment and whereby the torque entrainer is in contact with the mandrel at a contact surface of the mandrel, whereby the mandrel exhibits a cross section that is perpendicular to a longitudinally extending axis of the screw and intersects the contact surface, whereby on the cross section, the mandrel exhibits a stress concentration factor (in accordance with DIN 743-2 Section 5) of less than 2.0. It is preferred that, on the cross section, the mandrel exhibits a stress concentration factor of less than 1.75, preferably less than 1.5, particularly preferably no more than 1.4, at most 1.3 or at most 1.25.

For mandrel geometries according to the state of the art (here specifically according to FIG. 1), the prototype calculations herein showed a stress concentration factor α (alpha) characterizing the notching of 2.21 to 2.39. In contrast, an exemplary design according to the disclosure has a stress concentration factor alpha of approximately 1.19 to 1.34.

According to a third aspect of the present disclosure, a screw is provided for use in an extruder, whereby the screw exhibits a mandrel and a number of segments held on the mandrel and disposed axially to one another, whereby a separate torque entrainer is disposed between the mandrel and one segment and whereby the torque entrainer is in contact with the mandrel at a contact surface of the mandrel, whereby the profile of the contact surface in the cross section of the mandrel starts to deviate with respect to a circular surround by a first, positive angle, whereby the first angle is less than 90°, and, by a second, likewise positive angle, it again converges with the surround, whereby sum of the negative angles is less than 90°, in particular less than 45°. Most notably, the sum of the negative angles can be less than 10°, in particular 0°.

In the geometry according to FIG. 1, for example, the sum of the negative angles is 90°, namely exactly the −90° of the edge of the fillet of the contact surface. In this version the two positive angles are: the first angle approximately 30°, the second angle exactly 90°.

In the geometry according to FIG. 2, on the other hand, the sum of the negative angles is zero. The two positive angles are both approximately 45°.

According to a fourth aspect of the disclosure, a screw is provided for use in an extruder, whereby the screw exhibits a mandrel and a number of segments held on the mandrel and disposed axially to one another, whereby a separate torque entrainer is disposed between the mandrel and one segment and whereby the torque entrainer is in contact with the mandrel at a contact surface of the mandrel, whereby the torque entrainer rests against the contact surface with exactly one side of its contour.

On the other hand, with conventional screws, only the use of feather keys is known, which rest against the contact surface with two sides (see FIG. 1) or with three sides.

In general it will be easiest for the mandrel to be partially congruent in cross section with a circular surround. The mandrel can then be machined, in particular milled, from a shaft with a circular cross section.

The mandrel is a shaft, the cross section of which deviates from the circular, specifically deviates from a theoretical circular surround, usually toward the inside. The manufacturing is possible, for example, by reworking a shaft with an originally circular cross section in its cross section by removing material. Even independent of the manufacturing method of the mandrel proposed here, manufacturing would be particular easy, if the respective part of the circumference of the mandrel in cross section is circular to as large an extent as possible, i.e. in cross section the mandrel is partially congruent with its theoretical circular surround to as large an extent as possible, for example over at least half of its specific, measured controlled circumference.

There will be a tendency for the part of the circumference that is partially congruent with the circular surround to become smaller, the more contact surfaces with torque entrainers are provided.

The contact surface deviating from the surround at obtuse angles already helps to reduce the stress peaks in the mandrel.

An “obtuse angle” is an angle that is greater than pi/2, but less than pi, in degrees therefore greater than 90°, but less than 180°.

This feature should be understood to mean that, when the transition from the theoretical circular surround of the mandrel into the contact surface is viewed in cross section, the contact surface deviates in relation to the surround by only obtuse angles.

In the calculations herein, a mandrel geometry has proven to be very promising, in which the contact surface is a chord between two circular arc segments on a cross section of the mandrel.

Mathematically-geometrically the “chord” is the shortest connection in the cross section between two ends of circular arc segments. It should be noted, however, that it does not necessarily have to be a mathematically ideal chord. Minor deviations from a direct, straight chord will still be able to adequately satisfy the aspect of the disclosure.

The two circular arc segments, between which the chord is to be placed to form the contact surface, can be separated from one another, so that there is at least one additional deviation from the circular arc shape between the circular arc segments on the cross section of the mandrel. There can, however, also be an otherwise continuous circular arc segment of the circular surround on the cross section being considered, whereby only the one chord is present in the cross section, so that only one torque entrainer can be fitted between the mandrel and the at least one segment present there in this considered cross section.

To distribute the loads as uniformly as possible in the mandrel, it is proposed that the mandrel is mirror symmetrical in cross section, in particular double mirror symmetrical.

It has already been noted that a number of torque entrainers can be provided around a circumference of the mandrel on one cross section. This too results in a reduction of stresses in the mandrel, because the overall required torque is introduced into the cross section of the mandrel via several discrete connections, namely the several torque entrainers on the considered cross section. As a result, the maximum expected surface pressure on each individual contact surface for each individual torque entrainer is reduced, even though the torsional stress can increase at the same time.

In cross section the torque entrainer can exhibit a wedge shape, whereby the wedge can in detail assume in a wide variety of different forms, i.e. with at least one partially rounded edge or otherwise, whereby there should in all cases be a first flat end and an elevated other end with respect to the flatness of the one end. The wedge is then no longer mirror symmetrical in the cross section of the screw, which in a suitable counter configuration of the screw segment toward the inside necessarily leads to torque entrainment.

Preferably, however, a variety of torque entrainers are present on one cross section of the screw and are point symmetrical with reference to the central axis of the screw; they are not mirror symmetrical, however, but rather asymmetrical in terms of theoretical mirror axes. Asymmetry makes it particularly easy to force instantaneous driving between the mandrel and the segments. Point symmetry allows the stresses in the mandrel to be distributed as uniformly as possible.

Designs in which one or more torque entrainers are mirror symmetrical to one another are conceivable as well.

Configurations in which the above-described features for symmetry are present for a number of torque entrainers on a cross section, but not for all, are conceivable as well. For example, for entrainment, one or more of the torque entrainers can be arranged in the opposite rotation direction.

According to a second aspect of the present disclosure, a method is provided for converting a screw of an extruder, whereby the screw exhibits a mandrel and a number of segments held on the mandrel and disposed axially to one another, with sealed segment boundaries, whereby a separate torque entrainer is disposed between the mandrel and one segment, whereby the torque entrainer is in contact with the mandrel at a contact surface of the mandrel, whereby the method includes the following steps: (a) removal of the segments from the mandrel, for example by means of axially pushing the segments from the mandrel; and (b) pushing the segments onto a mandrel with torque entrainers, whereby the torque entrainers are in contact with the mandrel at a contact surface of the mandrel and whereby the contact surface of the mandrel is notch free.

The presented second aspect of the disclosure has recognized that, even when using a notch-free or at least on the contact surface notch-free mandrel, the segments known from the state of the art can continue to be used, if just the torque entrainers are geometrically adapted, for example correspondingly adapted with feather keys.

It goes without saying that the presented advantages of the disclosure readily extend to an extruder, in particular a single screw extruder or a twin screw extruder, as well, if it exhibits a screw of the previously described type.

### BRIEF DESCRIPTION OF THE DRAWINGS

Based on an exemplary embodiment and with reference to the drawing, the disclosure is explained in greater detail in the following in comparison to a design according to the state of the art. The drawing shows

FIG. 1 schematically in a cross section a mandrel with two feather keys, according to the state of the art, as well as

FIG. 2 in an analogous view an exemplary inventive structure of a mandrel with two torque entrainers, each on a notch-free contact surface

### DETAILED DESCRIPTION OF THE DRAWINGS

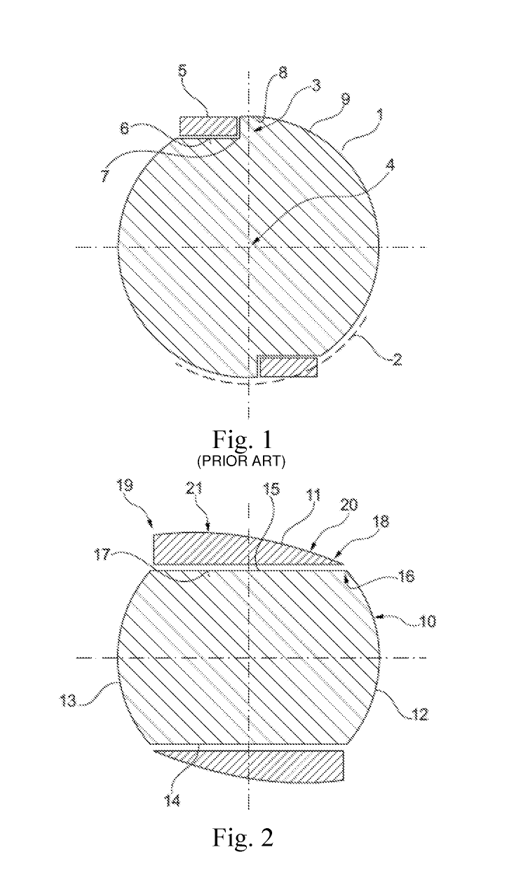

The conventional mandrel 1, shown in FIG. 1, substantially comprises a predominantly cylindrical solid material. In cross section the mandrel 1 is therefore congruent with a theoretically circular surround 2 (drawn at a slight distance for better recognizability). Two feather key grooves 3 (exemplarily numbered) are mounted over the circumference of the mandrel 1, however, so that in cross section the mandrel 1 is point symmetrical with respect to a screw axis 4.

A conventional feather key 5 is inserted in each of the feather key grooves 3. The feather key protrudes radially outward over the circular surround 2 of the mandrel 1, where in the assembled screw (not depicted) it cooperates with the inside of the segments (not depicted) in a positive-locking manner and ensures torque entrainment.

In the feather key groove 3, the feather key 5 rests against a notch-containing contact surface 6: the cross section of the mandrel 1 from the state of the art in the notch-containing contact surface 6 thus comprises two substantially straight profiles, which, however, exhibit a concave fillet 7 between them. In any case, as a result of the notch effect, there are high stress peaks here. There is also a right angle 8 on one side at a transition from a circular arc segment 9 into the notch-containing contact surface 6, which will likewise lead to an undesirably high stress concentration.

The inventive embodiment (see FIG. 2) being contrasted to it, also includes a mandrel, but a notch-free mandrel 10, and two wedge-shaped feather keys 11 (exemplarily numbered).

The notch-free mandrel 10—strictly speaking: the mandrel with notch-free contact surfaces—exhibits a specific number of circular arc segments 12, 13, here exactly two circular arc segments 12, 13, as well as two, here exactly two, chords 14, 15 in between.

The notch-free mandrel 10 is therefore double axially symmetrical.

In addition, the notch-free mandrel 10 does not exhibit a concave area nor a right, or more acute, angle. Rather, it includes only the two circular arc segments 12, 13, the two exactly straight chords 14, 15 and the obtuse-angled transitions 16 (exemplarily numbered).

The two chords 14, 15 serve as notch-free contact surfaces 17 (exemplarily numbered) for the two wedge-shaped feather keys 11.

As known from the state of that art, the notch-free mandrel 10 requires feather keys for a positive-locking transition of a torque from the mandrel to the screw segments.

The two wedge-shaped feather keys 11 ensure that this occurs.

Each wedge-shaped feather key 11 exhibits a flat first end 18 and an elevated second end 19.

In a first outside contour profile 20, the flat first end 18 of the wedge-shaped feather keys 11 has a preferably arcuate profile, namely in continuation of the theoretical circular surround (not depicted here), with which the circular arc segments 12, 13 are congruent. Only in another, second outside contour profile 21 the wedge-shaped feather keys 11 in cross section proceed outward out of the circular surround, and there provide for torque entrainment with respect to the segments.

The notch-free mandrel 10 of the inventive design of a screw is not only significantly more stable than the mandrel 1 according to the state of the art; it can also be procured much more easily and cost-effectively. In addition, with skillful selection of the geometry of the wedge-shaped feather keys 11, an outside contour of the overall structure of the notch-free mandrel 10 and the wedge-shaped feather keys 11, which is identical or at least largely identical to the overall outside contour of the mandrel 1 with the feather keys 5, can be achieved. Already existing screw segments can therefore be used with the new inventive notch-free mandrel 10 and its wedge-shaped feather keys 11 as well.

It should be expressly noted that, on a cross section, the torque entrainers can also be configured or disposed to entrain for rotation in the opposite direction. An exemplary embodiment therefore provides four torque entrainers, which are preferably identical in cross section, or disposed the other way around, so that they are configured as entrainers for both torque rotation directions.

1. A screw for use in an extruder, whereby the screw exhibits a mandrel and a plurality of segments held on the mandrel and disposed axially to one another, whereby between the mandrel and one of the plurality of segments, a separate torque entrainer is disposed and whereby the torque entrainer is in contact with the mandrel at a contact surface area of the mandrel, wherein the contact surface area is notch-free.

2. A screw for use in an extruder, whereby the screw exhibits a mandrel and a plurality of segments held on the mandrel and disposed axially to one another, whereby a separate torque entrainer is disposed between the mandrel and one of the plurality of segments and whereby the torque entrainer is in contact with the mandrel at a contact surface area of the mandrel, whereby the mandrel exhibits a cross section that is perpendicular to a longitudinally extending axis of the screw and intersects the contact surface area, wherein, on the cross section, the mandrel exhibits a stress concentration factor of less than 2.0.

3. The screw according to claim 2, wherein, on the cross section, the mandrel exhibits a stress concentration factor of less than 1.75 .

4. A screw for use in an extruder, whereby the screw exhibits a mandrel and a plurality of segments held on the mandrel and disposed axially to one another, whereby a separate torque entrainer is disposed between the mandrel and one of the plurality of segments and whereby the torque entrainer is in contact with the mandrel at a contact surface area of the mandrel, whereby the profile of the contact surface area in the cross section of the mandrel starts to deviate with respect to a circular surround by a first, positive angle and, by a second, positive angle, it converges with the surround, wherein a sum of the negative angles is less than 90.

5. The screw according to claim 4, wherein the sum of the negative angles is less than 10.

6. A screw for use in an extruder, whereby the screw exhibits a mandrel and a plurality of segments held on the mandrel and disposed axially to one another, whereby a separate torque entrainer is disposed between the mandrel and at least one of the segments and whereby the torque entrainer is in contact with the mandrel at a contact surface of the mandrel, wherein the torque entrainer rests against the contact surface area with exactly one side of its contour.

7. (canceled)

8. The screw according to claim 1, wherein in cross section, the mandrel is partially congruent with a circular surround.

9. The screw according to claim 1, wherein the contact surface area, at least in part, is a chord between two circular arc segments on a cross section of the mandrel.

10. The screw according to claim 1, wherein, in cross section, the mandrel is mirror symmetrical.

11. The screw according to claim 1, wherein, a number of torque entrainers are provided around a circumference of the mandrel.

12. The screw according to claim 1, wherein, in cross section, one torque entrainer exhibits a wedge shape, with a first flat end and a second thickened end.

13. The screw according to claim 1, wherein the torque entrainers on one cross section of the screw are asymmetrical, point symmetrical, or mirror symmetrical.

14. A Method for retooling a screw of an extruder, whereby the screw exhibits a mandrel and a plurality of segments held on the mandrel and disposed axially to one another, with sealed segment boundaries, whereby a separate torque entrainer is disposed between the mandrel and a segment, whereby the torque entrainer is in contact with the mandrel at a contact surface of the mandrel, the method including the following steps:
a. removing the plurality of segments from the mandrel;
b. pushing the segments onto a mandrel with torque entrainers, whereby the torque entrainers are in contact with the mandrel at a contact surface of the mandrel and whereby a screw according to claim 1 is created.

15. An extruder comprising a screw according to claim 1.
